(19) United States
(12) Patent Application Publication
(10) Pub. No.: US 2018/0074597 A1
(43) Pub. Date: Mar. 15, 2018

(54) KEYBOARD

(71) Applicant: PRIMAX ELECTRONICS LTD., Taipei (TW)

(72) Inventors: Wei-Yung Huang, Taipei (TW); Chun-Yuan Liu, Taipei (TW)

(21) Appl. No.: 15/348,675

(22) Filed: Nov. 10, 2016

(30) Foreign Application Priority Data
Sep. 9, 2016 (TW) 105129343

(51) Int. Cl. G06F 3/02

(52) U.S. Cl. CPC G06F 3/0219

(57) ABSTRACT

The present invention provides a keyboard, which includes a plurality of key structures. Each of the key structures includes an elastic piece, a filling piece, a membrane circuit board, and a movable support structure. The elastic piece is used for press by a user to trigger the membrane circuit board. The movable support structure is connected to the filling piece, and is located in an accommodating space defined by the elastic piece, so as to improve an overall structural strength. The elastic piece coats the filling piece and is co-injection molded with the filling piece; hardness of the filling piece is greater than that of the elastic piece, so as to improve hand feelings of pressing the elastic piece.

### FIELD OF THE INVENTION

The present invention relates to a keyboard, and more particularly to a keyboard having a key structure in which a soft material coats a hard material.

### BACKGROUND OF THE INVENTION

A keyboard is an indispensable device for using computers by modern people. A lot of keys are arranged on the keyboard for press by a user to enter an instruction. However, keycaps of conventional keyboards are made of hard plastics. Long-time stroke and press use may lead to discomfort of fingers of the user.

Therefore, rubber keycaps made of soft rubber also appear in the current market once in a while. However, the rubber keycaps made of soft rubber have an obvious disadvantage, that is, when a user presses the rubber keycaps, the rubber keycaps easily recess due to excessive softness; consequently, when the user presses the rubber keycaps, hand feelings of the rubber keycaps are obviously poor. Therefore, the current keyboards still have room for improvement.

### SUMMARY OF THE INVENTION

A main object of the present invention lies in providing a key structure in which an elastic piece coats a hard filling piece to improve press hand feelings.

Another object of the present invention lies in providing a movable support structure below an elastic piece to improve an overall structural strength.

A preferable implementation concept of the present invention lies in providing a keyboard, including a plurality of key structures, where each of the key structures includes:

an elastic piece, which includes a press top part and a circular skirt part that extends downwards from the press top part, where an inner surface of the circular skirt part encloses to define an accommodating space;

a filling piece, which includes a coated surface and an exposed surface, where the press top part coats the coated surface of the filling piece, and the exposed surface of the filling piece is exposed in the accommodating space, and hardness of the filling piece is greater than that of the elastic piece;

a membrane circuit board, provided below the elastic piece, and the press top part of the elastic piece is used for press by a user to trigger the membrane circuit board;

a support plate, located below the membrane circuit board and supporting the membrane circuit board; and

a movable support structure, provided in the accommodating space, where the movable support structure includes a first connection end portion and a second connection end portion, and the first connection end portion is connected to the exposed surface of the filling piece, and the second connection end portion penetrates through the membrane circuit board to be connected to the support plate.

In a preferable embodiment, the movable support structure is a scissor structure.

In a preferable embodiment, each of the key structures further includes a press layer, and the press layer is formed on an upper surface of the press top part; the elastic piece, the filling piece, and the press layer are formed by means of co-injection molding, and hardness of the press layer is greater than that of the elastic piece.

In a preferable embodiment, the elastic piece is made of rubber; the filling piece is made of plastics, and the elastic piece and the filling piece are formed by means of co-injection molding.

In a preferable embodiment, the keyboard further includes a keyboard frame surface, where the keyboard frame surface is provided above the membrane circuit board, and the keyboard frame surface includes a plurality of openings, and each of the key structures is correspondingly provided on one of the openings.

In a preferable embodiment, the keyboard frame surface includes a plurality of limiting structures, and each of the limiting structures defines one of the openings to limit the key structures.

In a preferable embodiment, the elastic piece, the filling piece, and the keyboard frame surface are formed by means of co-injection molding.

### BRIEF DESCRIPTION OF THE DRAWINGS

FIG. 1 is a schematic stereoscopic diagram of a keyboard of the present invention.

FIG. 2 is a schematic exploded view of a keyboard of the prevent invention in an angle.

FIG. 3 is a schematic exploded view of a keyboard of the prevent invention in another angle.

FIG. 4 is a schematic exploded view of co-injection molding of an elastic piece and a filling piece of a keyboard of the present invention in the another angle.

FIG. 5 is a schematic exploded view of co-injection molding of an elastic piece, a filling piece, and a keyboard frame surface of a keyboard of the present invention in the another angle.

FIG. 6 is a schematic sectional view of a keyboard of the present invention.

FIG. 7 is a schematic sectional view of a key structure that further includes a press layer of the keyboard of the present invention.

### DETAILED DESCRIPTION OF THE PREFERRED EMBODIMENT

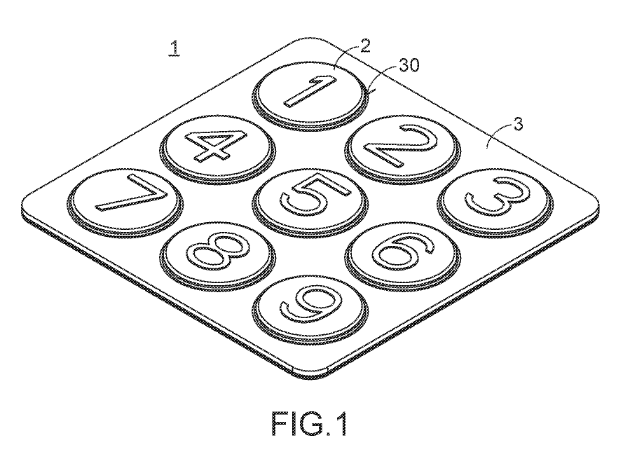

FIG. 1 is a schematic stereoscopic diagram of a keyboard of the present invention. A keyboard 1 of the present invention includes a plurality of key structures 2 and a keyboard frame surface 3; the keyboard frame surface 3 includes a plurality of openings 30; each of the key structures 2 is correspondingly provided on the openings 30 in a penetrating manner, so as to form a basic outline structure of the keyboard 1. It should be first noted that the number of the key structures 2 in the accompanying drawings of the present invention is nine, that is, nine key structures 2 being provided on a keyboard frame surface 3 is used as an example. However, certainly, the number in actual implementation is not limited thereto.

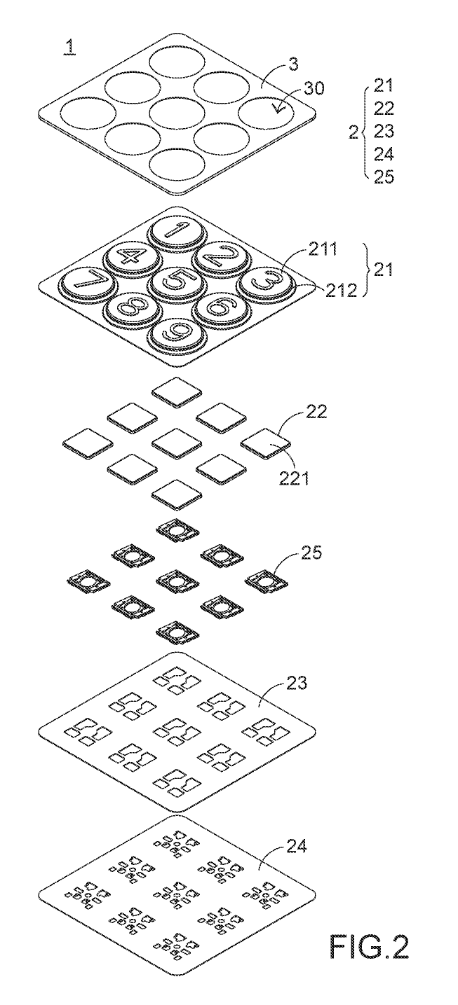

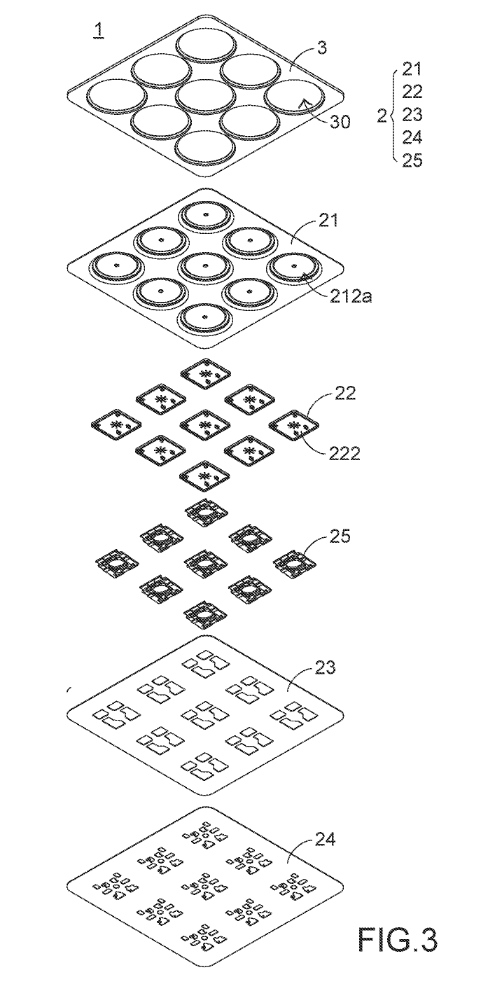

FIG. 2 and FIG. 3 are a schematic exploded view of a keyboard of the prevent invention in different angles. Please refer to FIG. 1 to FIG. 3 in combination. Each of the key structures 2 of the present invention includes an elastic piece 21, a filling piece 22, a membrane circuit board 23, a support plate 24, and a movable support structure 25. The elastic piece 21 includes a press top part 211 and a circular skirt part 212 that extends downwards from the press top part 211, where an inner surface of the circular skirt part 212 encloses to define an accommodating space 212a.

As shown in FIG. 2, a pattern or a typeface is printed on the press top part 211 for identification by a user, so that press can be executed. In the accompanying drawings of the present invention, numbers 1 to 9 are used as number key symbols, that is, the numbers 1 to 9 are places where the user performs identification and press. Preferably but non-limitatively, the elastic piece 21 of the present invention is made of a rubber material, and feels soft, so as to provide a soft contact surface for the user.

Please refer to FIG. 2 and FIG. 3 in combination. The filling piece 22 includes a coated surface 221 and an exposed surface 222, where the press top part 211 coats the coated surface 221 of the filling piece 22, and makes the exposed surface 222 exposed outside. Because at least a part of the filling piece 22 is located in the accommodating space 212a, the exposed surface 222 is exposed in the accommodating space 212a. Preferably but non-limitatively, the filling piece 22 of the present invention is made of a plastic material, and is hard. That is, hardness of the filling piece 22 of the present invention is greater than that of the elastic piece 21. Because the filling piece 22 is coated inside the elastic piece 21, the filling piece 22 may be used as a support article in structure. Therefore, when the user executes press, it feels soft to press the press top part 211 initially, but it feels hard to press deeper to a hard structure of the filling piece 22.

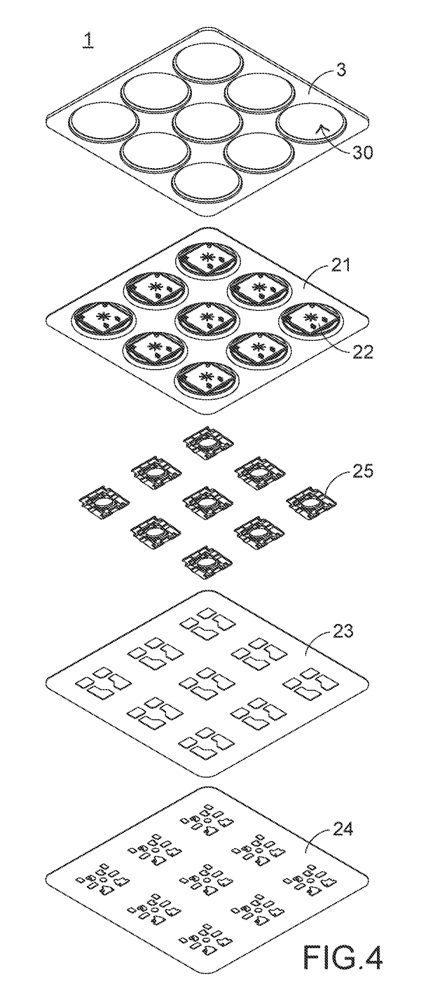

As shown in FIG. 4, FIG. 4 is a schematic exploded view of co-injection molding of an elastic piece and a filling piece of a keyboard of the present invention in the another angle. In a preferable implementation manner of the present invention, the elastic piece 21 is made of a rubber material; the filling piece 22 is made of a plastic material; and the elastic piece 21 and the filling piece 22 are formed by means of co-injection molding; that is, the elastic piece 21 and the filling piece 22 are integrally molded, so that an overall key architecture and a subsequent assembly process are simplified.

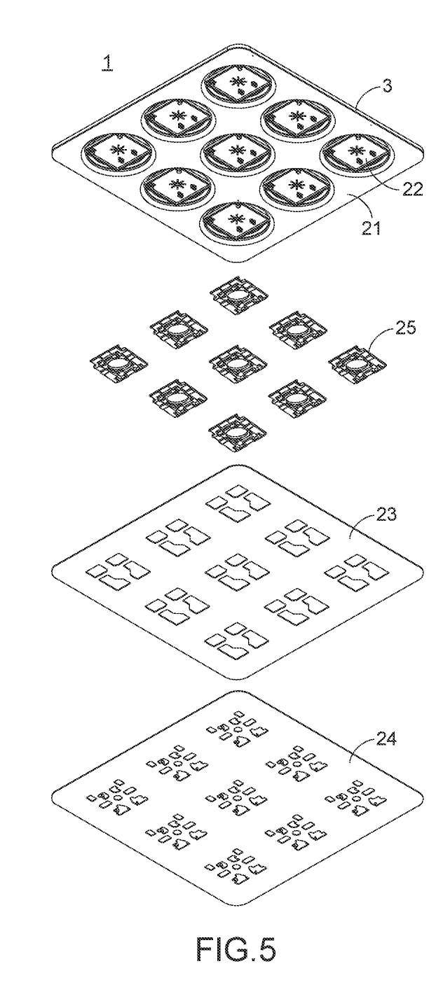

As shown in FIG. 5, FIG. 5 is a schematic exploded view of co-injection molding of an elastic piece, a filling piece, and a keyboard frame surface of a keyboard of the present invention in the another angle. In a preferable implementation manner, the elastic piece 21 is made of a rubber material; the filling piece 22 is made of a plastic material; and the elastic piece 21, the filling piece 22, and the keyboard frame surface 3 are formed by means of co-injection molding; that is, the elastic piece 21, the filling piece 22, and the keyboard frame surface 3 are integrally molded, so that an overall architecture and a subsequent assembly process are simplified.

As shown in FIG. 2 to FIG. 5, the membrane circuit board 23 is provided below the keyboard frame surface 3, the elastic piece 21, and the filling piece 22. A user triggers the membrane circuit board 23 by pressing the press top part 211 of the elastic piece 21, so as to generate an input signal. In addition, because the shape of the membrane circuit board 23 of the present invention is a thin film, a support plate 24 needs to be further provided below the membrane circuit board 23, so that the membrane circuit board 23 can be supported.

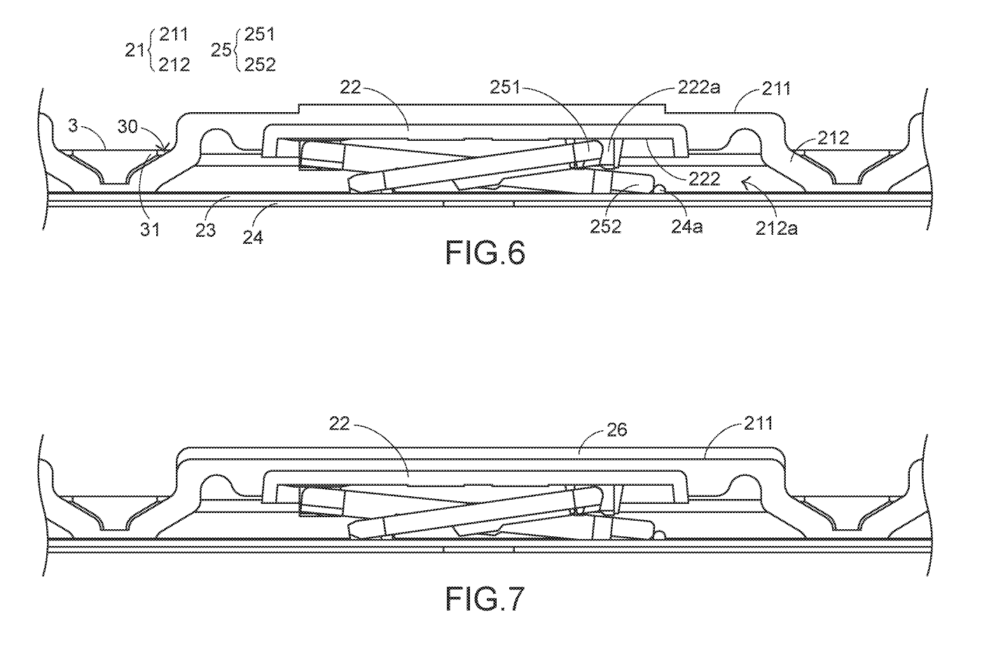

FIG. 6 is a schematic sectional diagram of a keyboard of the present invention. Please refer to FIG. 2 to FIG. 6 in combination. Further, the movable support structure 25 of the present invention is provided in the accommodating space 212a defined by the elastic piece 21. The movable support structure 25 includes a first connection end portion 251 and a second connection end portion 252; the first connection end portion 251 is connected to a hook structure 222a of the exposed surface 222 of the filling piece 22; and the second connection end portion 252 penetrates through the membrane circuit board 23 to be connected to a hook structure 24a of the support plate 24. In other words, by means of the present invention, the movable support structure 25 is provided in the accommodating space 212a below the elastic piece 21 as auxiliary support, so that a support strength of an overall structure of the key structure 2 is improved. In this embodiment of the present invention, the movable support structure 25 is a scissor structure, which is only an example, and the present invention is not limited thereto.

In addition, the keyboard frame surface 3 includes a plurality of limiting structures 31. The limiting structures 31 define the openings 30 respectively, and have a limiting function on the key structures 2 provided on the openings 30.

FIG. 7 is a schematic sectional view of a key structure that further includes a press layer of the keyboard of the present invention. A press layer 26 is formed on an upper surface of the press top part 211. The elastic piece 21, the filling piece 22, and the press layer 26 are formed by means of co-injection molding, and hardness of the press layer 26 is greater than that of the elastic piece 21, which is also a possible implementation manner.

Based on the above, the keyboard of the present invention provides a key structure, in which a soft elastic piece coats a hard filling piece, for press by a user, so that hand feelings and the comfort degree of the user in a press operation are improved. In addition, the advantage of improving the overall structural strength and the press hand feelings is achieved by providing a movable support structure below the elastic piece.

The foregoing embodiments are only for exemplarily describing principles and effects of the present invention, and illustrating and explaining technical features of the present invention, and are not intended to limit the protection scope of the present invention. Changes or equivalent arrangements that can be easily completed by any person skilled in the art without violating the technical principles and spirit of the present invention all belong to the scope claimed by the present invention. Therefore, the protection scope of the present invention is subject to the appended claims.

What is claimed is:

1. A keyboard, comprising a plurality of key structures, wherein each of the key structures comprises:
an elastic piece comprising a press top part and a circular skirt part that extends downwards from the press top part, wherein an inner surface of the circular skirt part encloses to define an accommodating space;
a filling piece comprising a coated surface and an exposed surface, wherein the press top part coats the coated surface of the filling piece, and the exposed surface of the filling piece is exposed in the accommodating space, and hardness of the filling piece is greater than that of the elastic piece;
a membrane circuit board, provided below the elastic piece, and the press top part of the elastic piece is used for press by a user to trigger the membrane circuit board;
a support plate, located below the membrane circuit board and supporting the membrane circuit board; and
a movable support structure, provided in the accommodating space, wherein the movable support structure includes a first connection end portion and a second connection end portion, and the first connection end portion is connected to the exposed surface of the filling piece, and the second connection end portion penetrates through the membrane circuit board to be connected to the support plate.

2. The keyboard according to claim 1, wherein the movable support structure is a scissor structure.

3. The keyboard according to claim 1, wherein each of the key structures further comprises a press layer, and the press layer is formed on an upper surface of the press top part; the elastic piece, the filling piece, and the press layer are formed by means of co-injection molding, and hardness of the press layer is greater than that of the elastic piece.

4. The keyboard according to claim 1, wherein the elastic piece is made of rubber; the filling piece is made of plastics, and the elastic piece and the filling piece are formed by means of co-injection molding.

5. The keyboard according to claim 1, further comprising a keyboard frame surface, wherein the keyboard frame surface is provided above the membrane circuit board, and the keyboard frame surface comprises a plurality of openings, and each of the key structures is correspondingly provided on one of the openings.

6. The keyboard according to claim 7, wherein the keyboard frame surface comprises a plurality of limiting structures, and each of the limiting structures defines one of the openings to limit the key structures.

7. The keyboard according to claim 7, wherein the elastic piece, the filling piece, and the keyboard frame surface are formed by means of co-injection molding.
